(19) United States
(12) Patent Application Publication
(10) Pub. No.: US 2006/0139537 A1
(43) Pub. Date: Jun. 29, 2006

(54) Liquid crystal display device having a wide viewing angle

(76) Inventors: Ku-Hyun Park, Uiwang-si (KR); Su-Seok Choi, Seongnam-si (KR)

Correspondence Address: MCKENNA LONG & ALDRIDGE LLP, 1900 K STREET, NW, WASHINGTON, DC, 20006, US

(21) Appl. No.: 11/166,159

(22) Filed: Jun. 27, 2005

(30) Foreign Application Priority Data
Dec. 28, 2004 (KR) 2004-0114302

(51) Int. Cl. G02F 1/1337

(52) U.S. Cl. 349/123

(57) ABSTRACT

A LCD device and method that improve contrast ratio, reduce grayscale inversion and light leakage without a retardation film. The LCD device includes: a first substrate and a second substrate facing the first substrate, the first and second substrates including a pixel region; a first electrode on an inner surface of the first substrate in the pixel region; a first alignment layer over the first electrode, the first alignment layer including a mesogenic material; a second electrode on an inner surface of the second substrate; a second alignment layer over the second electrode, the second alignment layer including a same material as the first alignment layer; a liquid crystal layer interposed between the first and second alignment layers; and first and second polarizers on outer surfaces of the first and second substrates, respectively, wherein the first and second alignment layers compensate retardation of the liquid crystal layer.

This application claims the benefit of Korean Patent Application No. 2004-114302, filed on Dec. 28, 2004, which is hereby incorporated by reference for all purposes as if fully set forth herein.

### BACKGROUND OF THE INVENTION

1. Field of the Invention

The present invention relates to a liquid crystal display device. More particularly the present invention relates to a liquid crystal display device having a wide viewing angle and a method of fabricating the same.

2. Description of the Related Art

Next generation LCD devices have been developed because of their lightweight, thin profile, and low power consumption characteristics.

In general, a liquid crystal display (LCD) device makes use of the optical anisotropy and polarization properties of liquid crystal molecules. The liquid crystal molecules have a definite orientational alignment that results from their thin and long shape. The alignment direction of the liquid crystal molecules can be controlled by application of an electric field to the liquid crystal molecules. Accordingly, as an intensity of the applied electric field changes, the alignment orientation of the liquid crystal molecules also changes. Because incident light through a liquid crystal material is refracted due to an orientation of the liquid crystal molecules resulting from the optical anisotropy of the aligned liquid crystal molecules, an intensity of the incident light can be controlled and images can be displayed.

Among the various types of LCD devices commonly used, active matrix LCD (AM-LCD) devices, in which thin film transistors (TFTs) and pixel electrodes connected to the TFTs are disposed in a matrix, have been developed because of their high resolution and superior display of moving images.

The LCD device includes upper and lower substrates, and a liquid crystal layer interposed therebetween. The upper substrate, which is referred to as a color filter substrate, has a common electrode and the lower substrate, which is referred to as an array substrate, has a pixel electrode. The liquid crystal layer is driven with an electric field generated between the common electrode and the pixel electrode. The LCD device having the common electrode and the pixel electrode on opposite substrates has excellent transmittance and aperture ratio. However, since the electric field is generated perpendicular to the upper and lower substrates, the LCD device has a poor viewing angle property. To solve the problem of narrow viewing angle, new LCD devices such as an in-plane switching (IPS) mode LCD device, where an electric field is laterally generated, may be used.

FIG. 1 is a schematic cross-sectional view of an in-plane switching mode liquid crystal display device according to the related art.

In FIG. 1, an upper substrate (a color filter substrate) 9 and a lower substrate 10 (an array substrate) face and are spaced apart from each other. A liquid crystal layer 11 is interposed between the upper and lower substrates 9 and 10. A pixel electrode 17 and a common electrode 30 are formed on an inner surface of the lower substrate 10. Although not shown, an upper alignment layer is formed between the upper substrate 9 and the liquid crystal layer 11 and a lower alignment layer is formed between the liquid crystal 11 and the lower substrate 10 having the common electrode 17 and the pixel electrode 30.

Although a portion of the liquid crystal layer 11 corresponding to the common electrode 17 and the pixel electrode 30 has no phase variation, another portion of the liquid crystal layer 11 corresponding to an interval between the common electrode 17 and the pixel electrode 30 has a phase variation in accordance with a horizontal electric field L in an ON state. That is, the liquid crystal layer 11 is driven by the horizontal electric field L generated between the pixel electrode 17 and the common electrode 30, thereby improving a viewing angle.

For example, users can see images having a respective viewing angle of about 80° to about 85° along top, bottom, right and left directions with respect to a normal direction of the in-plane switching mode LCD device.

Meanwhile, a vertical alignment liquid crystal display device is an example of another method to obtain a wider viewing angle.

FIG. 2 is a schematic cross sectional view showing a vertical alignment liquid crystal display device according to the related art. FIG. 3 is a schematic cross sectional view showing a vertical alignment LCD device including a retardation film having a discotic liquid crystal material according to the related art.

In FIG. 2, a first substrate 40 includes a thin film transistor Tr that has a gate electrode 42, a semiconductor layer 45, a source electrode 47 and a drain electrode 49. Further, a gate insulating layer 43 is formed between the gate electrode 42 and the semiconductor layer 45. A second substrate 60 includes a color filter layer 63 having red, green and blue color filters (not shown), and a common electrode 67, wherein the common electrode 67 has a first slit 68. A liquid crystal layer 90 is interposed between the first and second substrates 40 and 60, wherein the liquid crystal layer 90 includes a negative dielectric anisotropy. In addition, first and second polarizers 80 and 84 are disposed at outer surfaces of the first and second substrates 40 and 60, respectively, wherein a first transmission axis of the first polarizer 80 is perpendicular to a second transmission axis of the second polarizer 84. A retardation film 85 is disposed on an outer surface of the first polarizer 80. The retardation film 85 may be disposed on at least one of outer surfaces of the first and second polarizer 80 and 84.

To obtain a wide viewing angle, the vertical alignment liquid crystal display device should be manufactured as multi domains. In order to include the multi-domains, the pixel electrode 55 should includes a second slit 57 that is etched to induce a side electric field around the second slit 57. Various methods of fabricating the multi-domains can be used.

As explained above, the in-plane switching mode liquid crystal display device and the vertical alignment liquid crystal display device may be used for the wide viewing angle mode. However, when a user inclines an image surface of the LCD device with a predetermined angle with respect to a position having 45 degrees for a transmission axis of the polarizer, a contrast ratio of the devices is reduced and a gray scale inversion and light leakage occur in the LCD device.

The retardation film 85, which is disposed on at least one of the outer surfaces of the first and second polarizers, is utilized to solve the problems of the reduced the contrast ratio, the gray scale inversion and the light leakage at a definite angle.

In FIG. 3, a retardation film 85 for the vertical alignment LCD device includes a discotic liquid crystal material 94, wherein the retardation film 85 acts as a negative retardation film.

A liquid crystal layer 90 is interposed between first and second alignment layers 70 and 72, wherein the liquid crystal layer 90 corresponds to a positive minor axis medium in which an ideal refractive index is greater than a normal refractive index. Conversely, the discotic liquid crystal material 94 of the retardation film 85 has a negative minor medium in which the ideal refractive index is smaller than the normal refractive index, wherein the retardation film 85 is arranged so that a first optic axis OA1 of the liquid crystal layer 90 can be parallel with a second optic axis OA2 of the retardation film 85, thereby preventing the reduced contrast ratio, the gray scale inversion and a light leakage in a direction that the first and second transmission axes of the first and second polarizers 80 and 84 make 45 degrees with each other.

However, the retardation film 85 is manufactured to improve the wide viewing angle on an outer surface of the LCD device has a problem in that the fabricating costs and thickness of the LCD device are increased.

### SUMMARY OF THE INVENTION

Accordingly, the present invention is directed to a liquid crystal display device and a method of fabricating the same that substantially obviates one or more problems due to limitations and disadvantages of the related art.

An advantage of the present invention is to provide a liquid crystal display device and a method of fabricating the same that can improve a contrast ratio and reduce a gray scale inversion and a light leakage without a retardation film.

Another advantage of the present invention is to provide a liquid crystal display device and a method of fabricating the same that can reduce manufacturing costs.

Additional features and advantages of the invention will be set forth in the description that follows, and in part will be apparent from the description, or may be learned by practice of the invention. These and other advantages of the invention will be realized and attained by the structure particularly pointed out in the written description and claims hereof as well as the appended drawings.

To achieve these and other advantages and in accordance with the purpose of the present invention, as embodied and broadly described, a liquid crystal display device includes: a first substrate and a second substrate facing the first substrate, the first and second substrates including a pixel region; a first electrode on an inner surface of the first substrate in the pixel region; a first alignment layer over the first electrode, the first alignment layer including a mesogenic material; a second electrode on an inner surface of the second substrate; a second alignment layer over the second electrode, the second alignment layer including the same material as the first alignment layer; a liquid crystal layer interposed between the first and second alignment layers; and first and second polarizers on outer surfaces of the first and second substrates, respectively, wherein the first and second alignment layers compensating retardation of the liquid crystal layer.

In another aspect, a method of fabricating a liquid crystal display device includes: providing first and second substrates; forming a first electrode on the first substrate in a pixel region; forming a first alignment layer over the first electrode, the first alignment layer including a mesogenic material; forming a second electrode on the second substrate including the pixel region; forming a second alignment layer over the second electrode, the second alignment layer including a same material as the first alignment layer; attaching the first and second substrates so that the first and second alignment layers face each other; forming a liquid crystal layer between the first and second alignment layers; and forming first and second polarizers on outer surfaces of the first and second substrates, respectively, wherein the first and second alignment layers compensate retardation of the liquid crystal layer.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this application, illustrate embodiments of the invention and together with the description serve to explain the principle of the invention.

In the drawings:

FIG. 1 is a schematic cross-sectional view of an in-plane switching mode liquid crystal display device according to the related art.

FIG. 2 is a schematic cross sectional view showing a vertical alignment liquid crystal display device according to the related art.

FIG. 3 is a schematic cross sectional view showing a vertical alignment LCD device including a retardation film having a discotic liquid crystal material according to the related art.

FIG. 4 is a schematic cross-sectional view of a substrate having an alignment layer for a vertical alignment LCD device according to the related art.

FIG. 5 is a schematic cross-sectional view of a substrate having an alignment layer for a vertical alignment LCD device according to the present invention, wherein the alignment layer is made of a mesogenic material.

FIGS. 6A to 6D are schematic views of a motion of a side chain of an alignment layer made of a mesogenic material when an electric field is applied to the alignment layer (FIGS. 6B and 6D) and an electric field is not applied to the alignment layer (FIGS. 6A and 6C) according to the present invention, respectively.

FIGS. 7A to 7D are schematic views of a motion of a nematic liquid crystal director of an alignment layer made of a mesogenic material when an electric field is applied to the alignment layer (FIGS. 7B and 7D) and the electric field is not applied to the alignment layer (FIGS. 7A and 7C) according to the present invention, respectively.

FIGS. 8A and 8B are schematic cross sectional views of a vertical alignment LCD device in an OFF state and an ON state according to the present invention, respectively.

FIG. 9A is a schematic graph view of a vertical alignment LCD device according to the related art.

FIG. 9B is a schematic graph view of a vertical alignment LCD device according to the present invention.

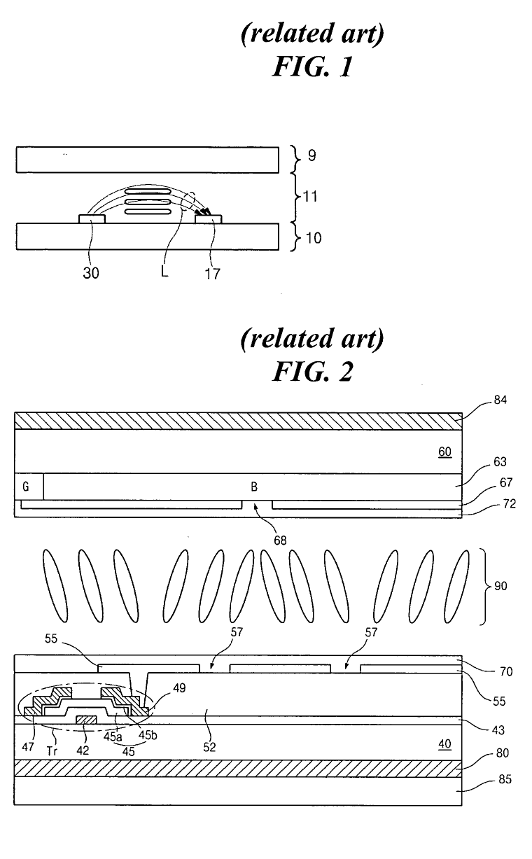

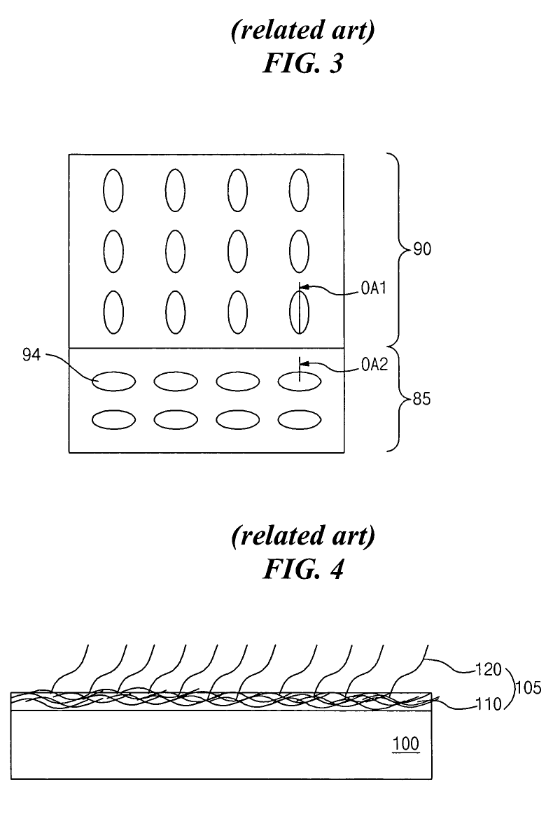

### DETAILED DESCRIPTION OF THE ILLUSTRATED EMBODIMENTS

Reference will now be made in detail to the illustrated embodiments of the present invention, examples of which are illustrated in the accompanying drawings. Wherever possible, the same reference numbers will be used throughout the drawings to refer to the same or like parts.

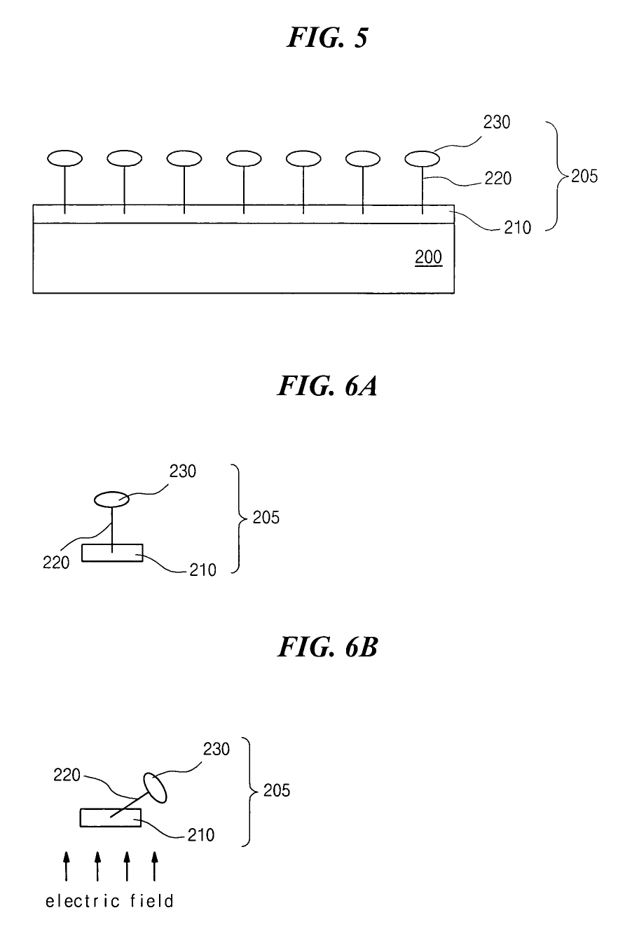

FIG. 4 is a schematic cross-sectional view of a substrate having an alignment layer for a vertical alignment LCD device according to the related art. FIG. 5 is a schematic cross-sectional view of a substrate having an alignment layer for a vertical alignment LCD device according to the present invention, wherein the alignment layer is made of a mesogenic material.

In FIG. 4, an alignment layer 105 for pre-alignment of a liquid crystal layer (not shown) is made of an organic polymer material such as a polyimide.

The alignment layer 105 includes a plurality of main chains 110, which get tangled with each other, and a plurality of side chains 120 connected to the plurality of main chains 110 and disposed outside of the plurality of main chains 110, wherein the plurality of side chains 120 is arranged along a defined direction by performing a step of rubbing using a predetermined roller. The liquid crystal layer is arranged along a defined direction by the arranged side chains 120.

When the arranged direction of the alignment layer 105 is determined, the arranged direction does not change without depending on applied electric field and maintains its arranged state.

Accordingly, the alignment layer 105 according to the related art has only a role of controlling the pre-arrangement of the liquid crystal layer.

On the other hand, in FIG. 5, an alignment layer 205 of the mesogenic material further includes a nematic liquid crystal director 230. Namely, the alignment layer 205 can control a retardation value by maintaining a predetermined position with the liquid crystal layer (not shown) by the nematic liquid crystal director 230, as well as arrange the pre-arrangement of the liquid crystal layer. Therefore, the LCD device having the alignment layer 205 can provide a wide viewing angle.

Specifically, the alignment layer 205 includes a field layer 210, a plurality of side chains 220 diverged from the field layer 210, and the nematic liquid crystal director 230 connected to an end portion of the plurality of side chains 220, wherein the field layer 210 corresponds to the mentioned main chains 110 of the alignment layer 105 in FIG. 4.

Here, a major axis of the nematic liquid crystal director 230 is substantially parallel with the field layer 210 in an OFF state.

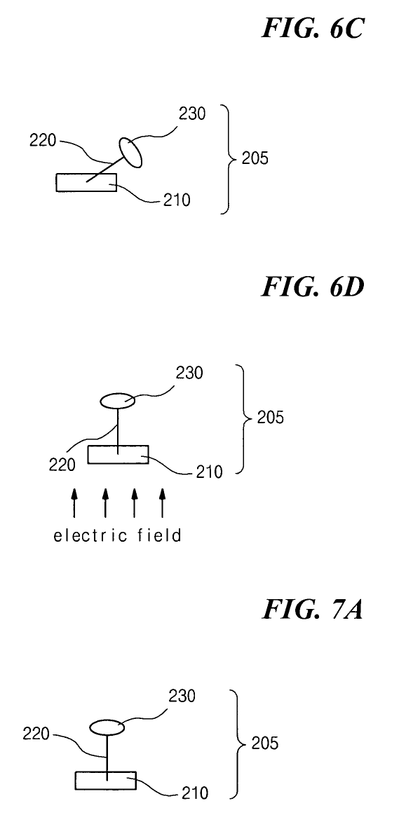

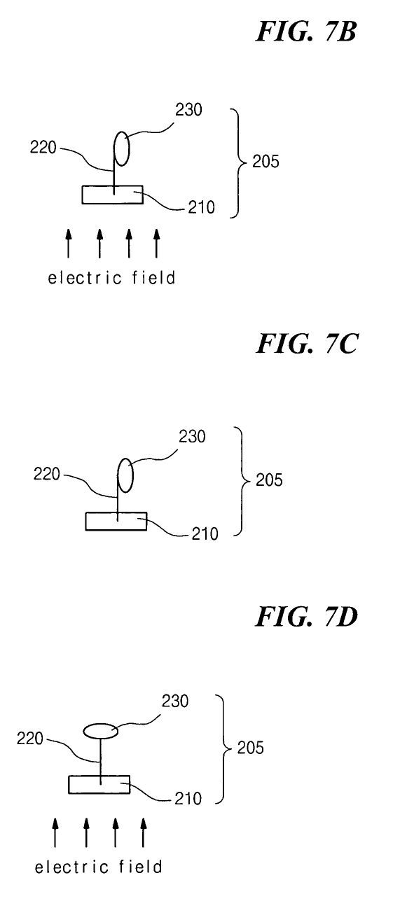

FIGS. 6A to 6D are schematic views of a motion of a side chain of an alignment layer made of a mesogenic material when an electric field is applied to the alignment layer (FIGS. 6B and 6D) and when an electric field is not applied to the alignment layer (FIGS. 6A and 6C) according to the present invention, respectively. FIGS. 7A to 7D schematic views of a motion of a nematic liquid crystal director of an alignment layer made of a mesogenic material when an electric field is applied to the alignment layer (FIGS. 7B and 7D) and when an electric field is not applied to the alignment layer (FIGS. 7A and 7C) according to the present invention, respectively.

In FIGS. 6A and 6B, although an alignment layer 205 made of a mesogenic material includes a side chain 220 that maintains a vertical state with respect to a field layer 210 of the alignment layer 205 before being applied an electric field to the LCD device, the side chain 220 moves with a uniform angle with respect to the field layer 210 based on an intensity of the electric field when the electric field is applied to the LCD device.

Conversely, as shown in FIGS. 6C and 6D, when the side chain 220 maintains a predetermined angle with respect to the field layer 210 before having an electric field applied to the LCD device, the side chain 220 is substantially perpendicular with the field layer 210 when the electric field is applied to the LCD device.

In FIGS. 7A and 7B, the nematic liquid crystal director 230 of the alignment layer 205 may variously move with respect to the field layer 210, wherein a major axis of the nematic liquid crystal director 230 can be changed from a parallel state to a vertical state by the electric field. Alternatively, the major axis of the nematic liquid crystal director 230 may be changed from a vertical state to a parallel state by the electric field as shown in FIGS. 7C and 7D.

However, the alignment layer may have three cases such that only the side chain 220 can react to the electric field, only the nematic liquid crystal director 230 can move by the electric field, or the side chain 220 and the nematic liquid crystal director 230 can simultaneously move by the electric field.

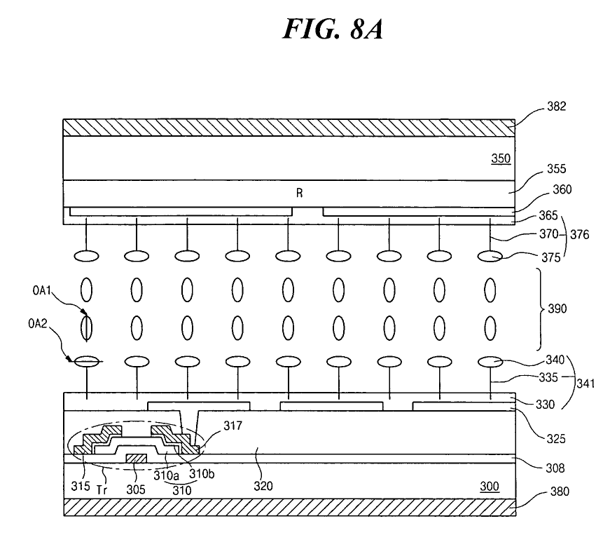

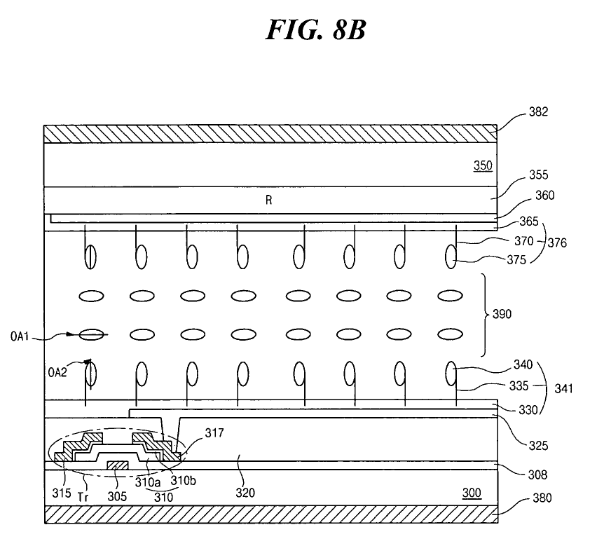

FIGS. 8A and 8B are schematic cross sectional views of a vertical alignment LCD device in an OFF state and an ON state according to the present invention, respectively.

In FIGS. 8A and 8B, a thin film transistor Tr, which has a gate electrode 305, a semiconductor layer 310 over the gate electrode 305, a source electrode 315 on the semiconductor layer 310, and a drain electrode 317 on the semiconductor layer 310 and spaced apart from the source electrode 315, are formed on a first substrate 300. Although not shown, the gate electrode 305 is connected to a gate line, the source electrode 315 is connected to a data line crossing the gate line, and a crossing region of the gate line and the data line is defined as a pixel region. A pixel electrode 325 is connected to the drain electrode 317 and a first alignment layer 341 is formed on the pixel electrode 325, wherein the first alignment layer 341 is made of a mesogenic material and includes a field layer 330, a plurality of side chains 335 and a plurality of nematic liquid crystal director 340. In addition, a first polarizer 380 is disposed on an outer surface of the first substrate 300. Further, a gate insulating layer 308 is formed between the gate electrode 305 and the semiconductor layer 310, and a passivation layer 320 is formed between the thin film transistor Tr and the pixel electrode 325.

A color filter layer 355 is formed on an inner surface of a second substrate 350, wherein the color filter layer 355 includes red, green and blue color filters (not shown). A common electrode 360 is formed on the color filter layer 355. For example, the common electrode 360 may be patterned to have a plurality of slits for forming multi domains with the pixel electrode 325.

A second alignment layer 376 is formed on the common electrode 360, wherein the second alignment layer 376 includes a field layer 365, a plurality of side chains 370 and a plurality of nematic liquid crystal directors 375. A second polarizer 382 is disposed on an outer surface of the second substrate 350, wherein a second polarization axis of the second polarizer 382 is substantially perpendicular with a first polarization axis of the first polarizer 380.

A liquid crystal layer 390 is interposed between the first and second alignment layers 341 and 376, wherein the liquid crystal layer 390 includes a vertical alignment nematic liquid crystal material. It is noted that a retardation value (Δ nd) of the first and second alignment layers 341 and 376 is within about 1 nanometer to about 300 nanometers.

When electric fields are applied to the pixel electrode 325 and the common electrode 360, respectively, an liquid crystal molecule in the liquid crystal layer 390 is in a parallel state with a defined angle with respect to surfaces of the first and second substrates 300 and 350 by the electric field from a vertical state that the electric field is not applied to the pixel electrode 325 and the common electrode 360, wherein a first optical axis OA1 of the liquid crystal molecule for the liquid crystal layer 390 is changed from a vertical state to the parallel state with respect to the surfaces of the first and second substrates 300 and 350. Also, a second optical axis OA2, the nematic liquid crystal directors 340, 360 of the first and second alignment layers 341 and 376 is changed from the parallel state to a vertical state by the applied electric field, thereby compensating a retardation of the liquid crystal layer 390 by maintaining the vertical state between the first optical axis OA1 of the liquid crystal layer 390 and the second optical axis OA2 of the nematic liquid crystal director 375.

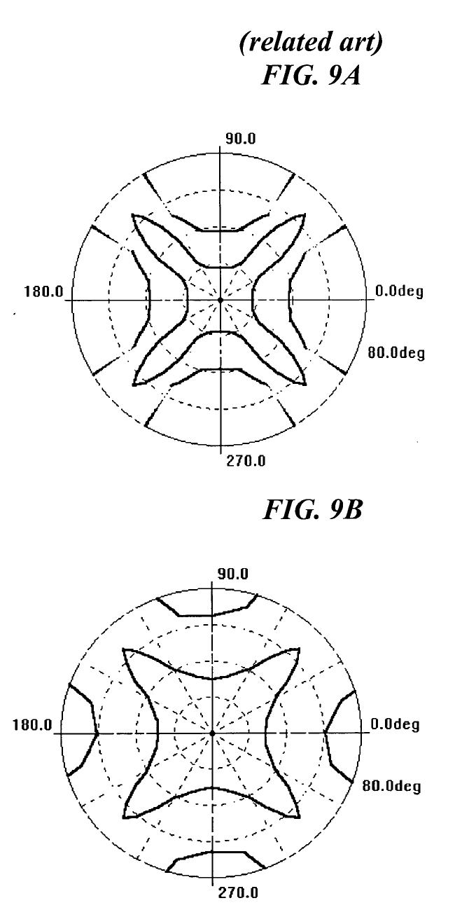

FIG. 9A is a schematic graph view of a vertical alignment LCD device according to the related art. FIG. 9B is a schematic graph view of a vertical alignment LCD device according to the present invention.

In FIGS. 9A and 9B, the graphs show when a user sees a surface displaying an image with about maximum 80 degrees, wherein a plurality of concentric circles having different radii that have the same starting point is spaced from each other by about 20 degrees. First to fourth boundaries correspond to what the user sees the image surface with about 20, 40, 60, 80 degrees with respect to a normal line along a perpendicular direction from a center portion, respectively.

In addition, an X axis and a Y axis are shown with respect to the starting point of the first and fourth concentric circles. Specifically, 0.0, 90.0, 180.0 and 270.0 deg (degrees) in accordance with X axis, Y axis, −X axis and −Y axis correspond to 3, 12, 9 and 6 hours of a clock when the user views the image surface rotating along an counterclockwise direction, respectively. A plurality of contour lines illustrated inner of the first and fourth concentric circles includes a first contour line, which is disposed at the innermost position, having 1:100 contrast ratio, and a second contour line, which is disposed at the most outer position, having 1:10 contrast ratio, wherein the contrast ratio is a determined definition of a picture plane using the contrast between black and white, and it may be defined as a white luminance value in a center portion of the picture plane divided by a black luminance value. In general, when the contrast ratio is greater than 1:10, an image quality dividing a gray scale level is reduced. Therefore, a test range is determined when the contrast ratio is more than 1:10 as a term evaluating the wide view angle.

In FIG. 9A, when the user views the image surface with more than 40 degrees with respect to the normal line perpendicular with the image surface, the contrast ratio is reduced and the image quality is depressed. Therefore, only a viewing angle having about 40 degrees along top, bottom, right and left direction is obtained.

However, since the LCD device according to the present invention can be compensated without a retardation film, the contrast ratio can be 1:10 although the user sees the image plane with about 60 degrees with respect to the normal line. Therefore, the LCD device according to the present invention can be improved more than 20 degrees in comparison with the viewing angle according to the related art.

As shown in FIG. 9B, a region that has a viewing angle more than 80 degrees is provided.

In comparison with the related art, a region between about 35 degrees to about 55 degrees with respect to the X axis can obtain a viewing angle of about 80 degrees, but the LCD device according to the related art can obtain a viewing angle more than 80 degrees in a region between about 10 degrees to 80 degrees with respect to X axis. Therefore, the LCD device according to the present invention can obtain the region having a wider viewing angle.

Next, a method of fabricating a vertical alignment LCD device will be explained with reference to FIG. 8A of the present invention.

A first electrode is formed on a first substrate in a pixel region, a first alignment layer is formed over the first electrode, wherein the first alignment layer includes a mesogenic material. Specifically, a gate line and a data line cross a gate line to define a pixel region formed on the first substrate. A thin film transistor is formed at a crossing point of the gate line and the data line and includes a gate electrode, a semiconductor layer, a source electrode and a drain electrode. The first electrode is connected to the thin film transistor.

A second electrode is formed on a second substrate including the pixel region, a second alignment layer is formed over the second electrode, wherein the second alignment layer includes the same material as the first alignment layer. Specifically, a black matrix is formed on the second substrate corresponding to the gate line and the data line, a color filter layer is formed on the black matrix, wherein the color filter layer includes red, green and blue color filters repeatedly arranged on the black matrix. Here, the color filter layer is disposed between the second electrode and the black matrix.

Each of the first and second alignment layers includes a field layer, a side chain connected to the field layer and a nematic liquid crystal director on an end portion of the side chain. More specifically, the step of forming the first and second alignment layers includes printing a mesogenic material using a coating apparatus on the substrate to form an alignment layer, heating the alignment layer using curing apparatus such as an oven to cure the alignment layer, and rubbing the alignment layer to arrange the side chain and the nematic liquid crystal director with a predetermined direction.

A plurality of spacers is scatted on one of the first and second substrates having the first and second alignment layers to provide a cell gap. In addition, a silver (Ag) dot is formed on the outside of one of the first and second substrates with a uniform interval for an adjacent dot to connect a common line of the first substrate and the common electrode of the second substrate.

A seal pattern is formed on an outline of another of the first and second substrates. Next, the first and second substrates are attached with the seal pattern to face the first and second alignment layers. A liquid crystal layer is dropped on one of the first and second substrate, wherein the liquid crystal layer includes a nematic liquid crystal having a characteristic that is arranged with a vertical state.

The step of scattering the plurality spacers may be omitted when a patterned spacer is already on one of the first and second substrates. Also, the step of forming the silver dot may be omitted in an in-plane switching LCD device since the common electrode and the pixel electrode are formed on the same substrate in the in-plane switching LCD device.

After that, the first and second substrates having the liquid crystal layer are aligned to face each other and are attached using a vacuum attaching apparatus under a vacuum atmosphere. After contacting the two substrates, the vacuum atmosphere is changed to an atmospheric pressure, and hence an inner portion between the two substrates remains in the vacuum state and the outer portion therebetween has the atmospheric pressure. Therefore, the two substrates adhere by the atmospheric pressure, but adherence between the two substrates ends by the spacer. Accordingly, the dropped liquid crystal layer is uniformly spread with respect to the whole region of the active area of the two substrates.

Next, the seal pattern is cured by irradiating one of the two substrates using an ultra violet light or by heating the two substrates under a predetermined temperature, and then the LCD panel having a plurality of active areas is scribed by a LCD panel unit having one active area.

A printed circuit board (PCB) is attached on an end portion of the LCD panel unit. First and second polarizers are attached on outer surfaces of the first and second substrates, respectively. In addition, a backlight unit is disposed under the first polarizer, wherein the backlight unit includes a plurality of optical sheets and at least one lamp. The vertical alignment LCD device is completed by the above-described plurality of processes. When an electric field is applied to the LCD device, the side chain and the liquid crystal director of each the first and second alignment layers react to the electric field, wherein the nematic liquid crystal director are perpendicular with the liquid crystal layer which has a characteristic of a vertical arrangement. Therefore, retardation of the liquid crystal layer is compensated by the first and second alignment layer of the mesogenic material, thereby improving a viewing angle without a retardation film. Specifically, it is not necessary to have a retardation film on an outer surface of the substrate.

Consequently, the vertical alignment LCD device utilizes an alignment layer of a mesogenic material, wherein the alignment layer includes a field layer, a side chain and further includes a nematic liquid crystal layer director perpendicular to the liquid crystal layer. Therefore, the LCD device can obtain a wider viewing angle without a compensation film such as a retardation film, reduce manufacturing costs and a slimmer/thinner model by omitting the compensation film.

It will be apparent to those skilled in the art that various modifications and variation can be made in the present invention without departing from the spirit or scope of the invention. Thus, it is intended that the present invention cover the modifications and variations of this invention provided they come within the scope of the appended claims and their equivalents.

What is claimed is:

1. A liquid crystal display device, comprising:
a first substrate and a second substrate facing the first substrate, the first and second substrates including a pixel region;
a first electrode on an inner surface of the first substrate in the pixel region;
a first alignment layer over the first electrode, the first alignment layer including a mesogenic material;
a second electrode on an inner surface of the second substrate;
a second alignment layer over the second electrode, the second alignment layer including a same material as the first alignment layer;
a liquid crystal layer interposed between the first and second alignment layers; and
first and second polarizers on outer surfaces of the first and second substrates, respectively,
wherein the first and second alignment layers compensate retardation of the liquid crystal layer.

2. The device according to claim 1, wherein the liquid crystal layer is a vertical alignment liquid crystal.

3. The device according to claim 1, wherein each of the first and second alignment layers includes a field layer, a side chain connected to the field layer and a liquid crystal director connected to an end portion of the side chain.

4. The device according to claim 3, wherein the liquid crystal director is a nematic liquid crystal director.

5. The device according to claim 3, wherein at least one of the side chain and the liquid crystal director reacts to an electric field and moves in a particular direction when the electric field is applied to the liquid crystal layer.

6. The device according to claim 5, wherein a major axis of the liquid crystal director is substantially parallel to the field layer in an OFF state and is substantially perpendicular to the field layer in an ON state.

7. The device according to claim 5, wherein a major axis of the liquid crystal director is substantially perpendicular to the field layer in an OFF state and is substantially parallel to the field layer in an ON state.

8. The device according to claim 3, wherein an optical axis of the liquid crystal layer is substantially perpendicular to an optical axis of the liquid crystal director.

9. The device according to claim 1, wherein each of the first and second alignment layers includes a retardation value within about 1 nanometer (nm) to about 300 nanometers (nm).

10. The device according to claim 1, further comprising a gate line on the inner surface of the first substrate, a data line crossing the gate line to define the pixel region, and a thin film transistor at the crossing of the gate line and the data line, wherein the thin film transistor is connected to the first electrode.

11. The device according to claim 1, further comprising a color filter layer between the second substrate and the second electrode.

12. The device according to claim 11, wherein the color filter layer includes red, green and blue color filters, each of the red, green and blue color filters being in the pixel region.

13. A method of fabricating a liquid crystal display device, comprising: providing first and second substrates;
forming a first electrode on the first substrate in a pixel region;
forming a first alignment layer over the first electrode, the first alignment layer including a mesogenic material;
forming a second electrode on the second substrate including the pixel region;
forming a second alignment layer over the second electrode, the second alignment layer including a same material as the first alignment layer;
attaching the first and second substrates so that the first and second alignment layers face each other;
forming a liquid crystal layer between the first and second alignment layers; and
forming first and second polarizers on outer surfaces of the first and second substrates, respectively,
wherein the first and second alignment layers compensate retardation of the liquid crystal layer.

14. The method according to claim 13, wherein the liquid crystal layer is a vertical alignment liquid crystal.

15. The method according to claim 13, wherein forming first and second alignment layers includes forming a field layer, a side chain connected to the field layer and a liquid crystal director connected to an end portion of the side chain.

16. The method according to claim 15, wherein the liquid crystal director is a nematic liquid crystal director.

17. The method according to claim 15, wherein at least one of the side chain and the liquid crystal director reacts to an applied electric field and moves in a particular direction when the electric field is applied to the liquid crystal layer.

18. The method according to claim 17, wherein a major axis of the liquid crystal director is substantially parallel to the field layer in an OFF state and is substantially perpendicular to the field layer in an ON state.

19. The method according to claim 17, wherein a major axis of the liquid crystal director is substantially perpendicular to the field layer in an OFF state and is substantially parallel to the field layer in an ON state.

20. The method according to claim 15, wherein an optical axis of the liquid crystal layer is perpendicular to an optical axis of the liquid crystal director.

21. The method according to claim 13, wherein each of the first and second alignment layers includes a retardation value within about 1 nanometer (nm) to about 300 nanometers (nm).

22. The method according to claim 13, further comprising forming a gate line on the inner surface of the first substrate, forming a data line crossing the gate line to define the pixel region, and forming a thin film transistor at the crossing of the gate line and the data line, wherein the thin film transistor is connected to the first electrode.

23. The method according to claim 13, further comprising of forming a color filter layer between the second substrate and the second electrode.

24. The method according to claim 23, wherein the color filter layer includes red, green and blue color filters, each of the red, green and blue color filters in the pixel region.
